(19) United States
(12) Patent Application Publication
(10) Pub. No.: US 2015/0220255 A1
(43) Pub. Date: Aug. 6, 2015

(54) INFORMATION PROCESSING APPARATUS, INFORMATION PROCESSING METHOD, AND RELATED PROGRAM

(71) Applicant: CANON KABUSHIKI KAISHA, Tokyo (JP)

(72) Inventor: Ryo Maeda, Yokohama-shi (JP)

(21) Appl. No.: 14/422,202

(22) PCT Filed: Jul. 30, 2013
(86) PCT No.: PCT/JP2013/004599

§ 371 Date: Feb. 18, 2015

(30) Foreign Application Priority Data
Aug. 20, 2012 (JP) 2012-181858

(51) Int. Cl. G06F 3/0484; G06F 3/041; G06F 3/0488

(52) U.S. Cl. CPC G06F 3/04845; G06F 3/04842; G06F 3/0488; G06F 3/041

(57) ABSTRACT

An information processing apparatus includes a determination unit configured to determine whether an input direction of a gesture instruction received by a receiving unit coincides with an orientation being set beforehand, a display scale determination unit configured to determine whether to increase or decrease a display scale based on a determination result obtained by the determination unit, and a display control unit configured to change the display scale of the image data according to a determination result obtained by the display scale determination unit and display the changed image data.

### TECHNICAL FIELD

The present invention relates to an information processing apparatus, an information processing method, and a related program.

### BACKGROUND ART

An information processing apparatus equipped with a touch panel is conventionally available. Such an information processing apparatus can display digital image data on a display unit to enable a user to confirm the content of stored digital image data (hereinafter, referred to as “preview”). The apparatus enables a user to perform a touch operation on a screen in such a way as to select an arbitrary size for an image to be displayed on the screen. Thus, for example, a touch panel can be provided on a display unit equipped in a copying machine.

The copying machine performs a preview display operation before starting a print operation of an image obtained through scan processing. A user performs a touch operation to display an enlarged image, so that details of the displayed image can be confirmed. Further, the user can change a display position by performing a touch operation when an enlarged image is displayed.

Further, a zoom button is operable when a user changes the size of an image displayed on the screen. Although such a button operation is familiar to numerous users, a specific position of the image is set as a reference point in the size change operation. Therefore, it is necessary for each user to perform a scroll operation after the size change operation if the user wants to confirm an intended portion of the displayed image.

To solve the above-mentioned problem, as discussed in Japanese Patent Application Laid-Open No. 2011-28679, it is conventionally known to change the size of an image to be displayed by pressing the zoom button during a touch operation. According to the technique discussed in Japanese Patent Application Laid-Open No. 2011-28679, a position on a screen touched by a user while pressing the zoom button is set as a reference point when the display size is controlled.

According to the above-mentioned conventional technique, it is feasible to change the size of an image to be displayed while setting an arbitrary position as a reference point. However, according to the above-mentioned conventional technique, a user performs a button operation to determine a change amount in the display size. Therefore, the change amount in the display size becomes discrete and usability may deteriorate when a user confirms the content of image data when the size of the image data is changed.

### CITATION LIST

### Patent Literature

PTL 1: Japanese Patent Application Laid-Open No. 2011-28679

### SUMMARY OF INVENTION

The present invention is directed to an information processing technique that enables a user to enlarge and/or reduce image data in an intended manner and further enables the user to confirm enlarged or reduced image data easily.

According to an aspect of the present invention, an information processing apparatus includes a display control unit configured to display image data, a receiving unit configured to receive a gesture instruction from a user with respect to the image data displayed by the display control unit, a determination unit configured to determine whether an input direction of the gesture instruction received by the receiving unit coincides with an orientation being set beforehand, a display scale determination unit configured to determine whether to increase or decrease a display scale based on a determination result obtained by the determination unit, and a display control unit configured to change the display scale of the image data according to a determination result obtained by the display scale determination unit and display the changed image data.

According to the present invention, a user can enlarge and reduce image data in an intended manner and can easily confirm the enlarged or reduced image data.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a hardware configuration of an MFP.

FIG. 2 illustrates an example of a preview image displayed on a display unit of the MFP.

FIG. 3 is a flowchart illustrating an example of information processing that can be performed by the MFP.

FIG. 4 illustrates a flick operation that can be performed by a user to change a page of a preview image to be displayed, instead of using a page scroll button.

FIG. 5 illustrates a pinch-in operation or a pinch-out operation that can be performed by a user to change display scale (i.e., display magnification) of a preview image, instead of using a zoom button.

FIG. 6 illustrates a drag operation that can be performed by a user to change a display position, instead of using a viewing area selection button.

FIG. 7 illustrates a drag operation that can be performed by a user to change the display scale of a preview image and display a changed preview image.

FIG. 8 is a flowchart illustrating an example of preview image display scale changing processing.

### DESCRIPTION OF EMBODIMENTS

Various exemplary embodiments, features, and aspects of the invention will be described in detail below with reference to the drawings.

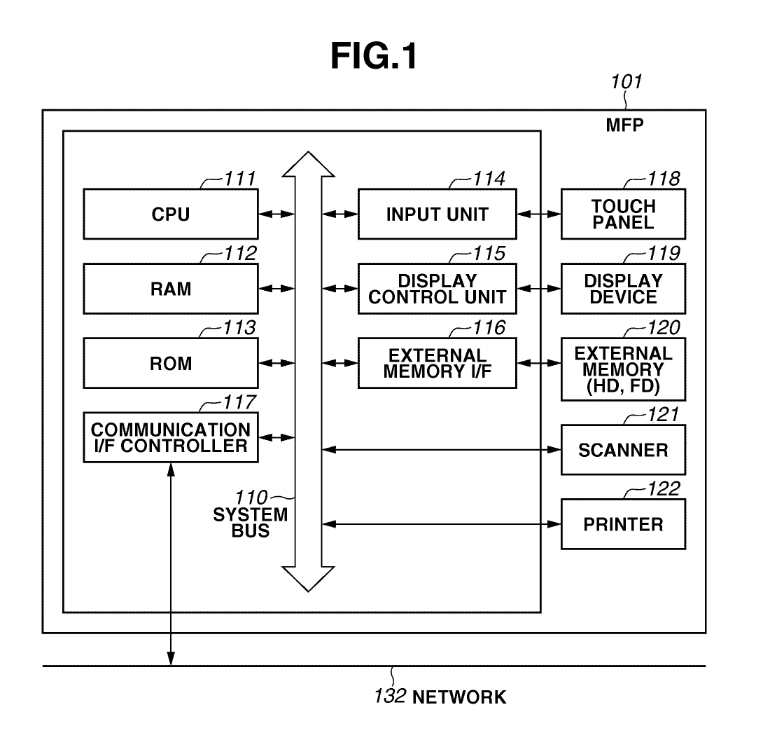

A first exemplary embodiment of the present invention is described below. FIG. 1 illustrates an example of a hardware configuration of a multi function peripheral (MFP) 101. The MFP 101 includes a central processing unit (CPU) 111, a random access memory (RAM) 112, a read only memory (ROM) 113, an input unit 114, a display control unit 115, an external memory interface (I/F) 116, and a communication I/F controller 117, which are mutually connected via a system bus 110. The MFP 101 further includes a scanner 121 and a printer 122 that are connected to the system bus 110. Each one of the above-mentioned components constituting the MFP 101 is configured to transmit and receive data to and from another component via the system bus 110.

The ROM 113 is a nonvolatile memory, which has predetermined memory areas to store image data and other data as well as programs required when the CPU 111 performs various operations. The RAM 112 is a volatile memory, which is usable as a temporary storage area, such as a main memory or a work area for the CPU 111. The CPU 111 can control constituent components of the MFP 101, for example, according to a program stored in the ROM 113, while using the RAM 112 as a work memory. The programs required when the CPU 111 performs various operations are not limited to the programs stored in the ROM 113 and include programs stored beforehand in an external memory (e.g., a hard disk) 120.

The input unit 114 can receive a user instruction and generate a control signal corresponding to the input operation. The input unit 114 supplies the control signal to the CPU 111. For example, the input unit 114 can be configured as an input device that receives user instructions. For example, the input unit 114 includes a keyboard as a character information input device (not illustrated) and a pointing device, such as a mouse (not illustrated) or a touch panel 118. The touch panel 118 is an input device that has a planar shape. The touch panel 118 is configured to output coordinate information corresponding to a touched position of the input unit 114.

The CPU 111 can control various constituent components of the MFP 101 according to a program based on a control signal generated by and supplied from the input unit 114 when a user inputs an instruction via the input device. Thus, the CPU 111 can control the MFP 101 to perform an operation according to the input user instruction.

The display control unit 115 can output a display signal to cause a display device 119 to display an image. For example, the CPU 111 supplies a display control signal to the display control unit 115, when the display control signal is generated, according to a program. The display control unit 115 generates a display signal based on the display control signal and outputs the generated display signal to the display device 119. For example, the display control unit 115 causes the display device 119 to display a graphical user interface (GUI) screen based on the display control signal generated by the CPU 111.

The touch panel 118 is integrally formed with the display device 119. The touch panel 118 is configured to prevent the display of the display device 119 from being adversely influenced by light transmittance. For example, the touch panel 118 is attached to an upper layer of a display surface of the display device 119. Further, input coordinates of the touch panel 118 and display coordinates of the display device 119 are in a one-to-one correspondence relationship. Thus, the GUI enables a user to feel as if a screen displayed on the display device 119 is directly operable.

The external memory 120 (e.g., a hard disk, a flexible disk, a compact disk (CD), a digital versatile disk (DVD), or a memory card) is attachable to the external memory I/F 116. Processing for reading data from the attached external memory 120 or writing data into the external memory 120 can be performed based on a control from the CPU 111.

The communication I/F controller 117 can communicate with an external device via a local area network (LAN), the internet, or an appropriate (e.g., wired or wireless) network based on a control supplied from the CPU 111. For example, a personal computer (PC), another MFP, a printer, and a server are connected to the MFP 101 via the network 132 so that each external apparatus can communicate with the MFP 101.

The scanner 121 can read an image from a document and generate image data. For example, the scanner 121 reads an original (i.e., a document to be processed) placed on a document positioning plate or an auto document feeder (ADF) and converts a read image into digital data. Namely, the scanner 121 generates image data of a scanned document. Then, the scanner 121 stores the generated image data in the external memory 120 via the external memory I/F 116.

The printer 122 can print image data on a paper or a comparable recording medium based on a user instruction input via the input unit 114 or a command received from an external apparatus via the communication I/F controller 117.

The CPU 111 can detect user instructions and operational states input via the touch panel 118, in the following manner. For example, the CPU 111 can detect a “touch-down” state where a user first touches the touch panel 118 with a finger or a pen. The CPU 111 can detect a “touch-on” state where a user continuously touches the touch panel 118 with a finger or a pen. The CPU 111 can detect a “move” state where a user moves a finger or a pen while touching the touch panel 118. The CPU 111 can detect a “touch-up” state where a user releases a finger or a pen from the touch panel 118. The CPU 111 can detect a “touch-off” state where a user does not touch the touch panel 118.

The above-mentioned operations and position coordinates of a point touched with a finger or a pen on the touch panel 118 are notified to the CPU 111 via the system bus 110. The CPU 111 identifies an instruction input via the touch panel 118 based on the notified information. The CPU 111 can also identify a moving direction of the finger (or pen) moving on the touch panel 118 based on a variation in position coordinates in the vertical and horizontal components of the touch panel 118.

Further, it is presumed that a user draws a stroke when the user sequentially performs a “touch-down” operation, a “move” operation, and a “touch-up” operation on the touch panel 118. An operation quickly drawing a stroke is referred to as “flick.” In general, a flick operation includes quickly moving a finger on the touch panel 118 by a certain amount of distance while keeping the finger in contact with the touch panel 118 and then releasing the finger from the touch panel 118.

In other words, when a user performs a flick operation, the user snaps a finger on the touch panel 118 in such a way as to realize a quick movement of the finger on the touch panel 118. When a finger moves at least a predetermined distance at a predetermined speed or more and then if a touch-up operation by a user is detected, the CPU 111 determines that the input instruction is the flick. Further, when a finger moves at least a predetermined distance and then if a touch-on operation by a user is detected, the CPU 111 determines that the input instruction is the drag.

The touch panel 118 can be any type of touch panel, which is selectable from the group of a resistive film type, a capacitance type, a surface acoustic wave type, an infrared type, an electromagnetic induction type, an image recognition type, and an optical sensor type.

The MFP 101 has a preview function as described below. In the present exemplary embodiment, the preview function refers to an operation of the MFP 101 that displays an image on the display device 119 based on image data stored in the RAM 112 or the external memory 120. The CPU 111 generates image data in a format suitable when it is displayed on the display device 119. In the following description, the image data having a suitable format is referred to as “preview image.” The image data stored in the external memory 120 can include a plurality of pages. In this case, the MFP 101 generates a preview image for each page.

Further, the CPU 111 can store image data in the RAM 112 or the external memory 120 according to at least one method. As one method, the CPU 111 can store image data generated from a document read by the scanner 121. As another method, the CPU 111 can store image data received from an external apparatus (e.g., PC) connected to the network 132 via the communication I/F controller 117. Further, as another method, the CPU 111 can store image data received from a portable storage medium (e.g., a universal serial bus (USB) memory or a memory card) attached to the external memory I/F 116. Any other appropriate method is employable to store image data in the RAM 112 or the external memory 120.

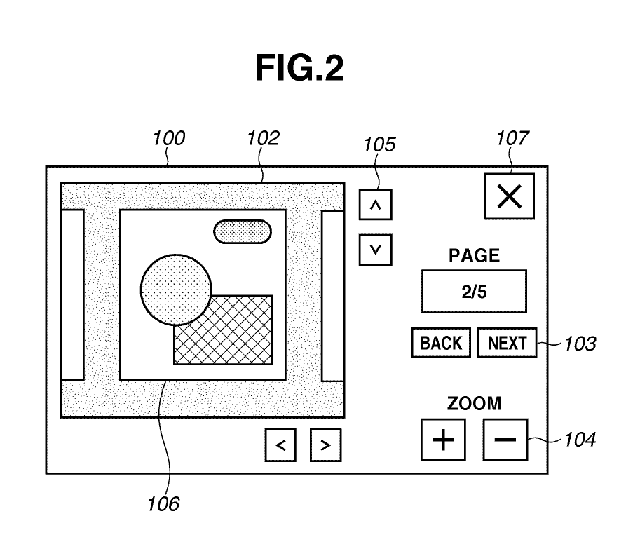

FIG. 2 illustrates an example state of a preview image displayed on the display device 119 of the MFP 101. A preview screen 100 illustrated in FIG. 2, which is a screen capable of displaying a preview image, includes a preview display area 102, a page scroll button 103, a zoom button 104, a viewing area selection button 105, and a closure button 107. The preview display area 102 is a display area in which a preview image 106 can be displayed. For example, the preview image can include a plurality of pages that are displayed simultaneously.

In FIG. 2, only one preview image is displayed in the preview display area 102. However, to indicate the presence of a preceding page and a following page, a preview image of the preceding page is partly displayed on the left end of the preview display area 102 and a preview image of the following page is partly displayed on the right end of the preview display area 102. The page scroll button 103 is operable when the preview images of the preceding and following pages are present. When the page scroll button 103 is pressed, the CPU 111 changes the preview image 106 to be displayed in the preview display area 102 toward a page positioned on the same side as the direction indicated by the pressed button.

The zoom button 104 enables a user to change the display scale (i.e., display magnification) of the preview image 106 to be displayed in the preview display area 102. The display scale can be set to one of a plurality of levels. The CPU 111 can select an appropriate display scale in response to a user instruction. Further, the CPU 111 can control enlarging/reducing the preview image 106 with a reference point being set at a specific position of the preview image 106.

The viewing area selection button 105 enables a user to change the display position of the preview image 106 to be displayed in the preview display area 102. When a user operates the zoom button 104 in such a way as to increase the display scale, an image that can be displayed in the preview display area 102 may be limited to only a part of the preview image 106. In such a case, the viewing area selection button 105 enables a user to display an arbitrary (or an intended) position of the preview image 106. The closure button 107 enables a user to close the preview screen 100 and open another screen. In other words, the closure button 107 is operable to terminate the preview function.

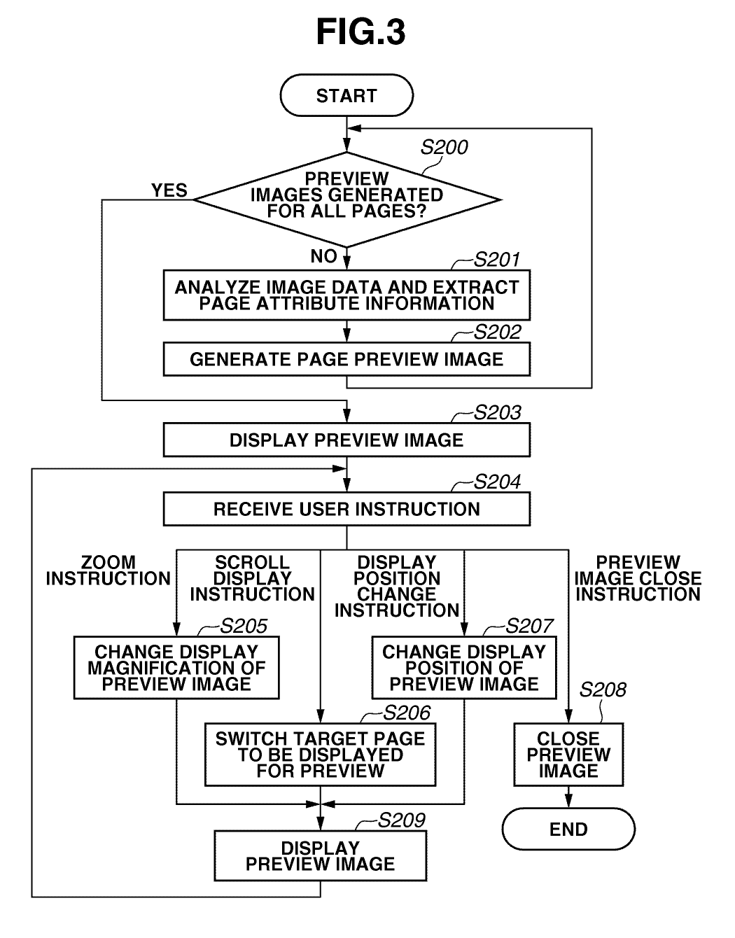

FIG. 3 is a flowchart illustrating details of processing to be executed by the MFP 101 when a user instructs the display of a preview image. To realize each step of the flowchart illustrated in FIG. 3, the CPU 111 of the MFP 101 executes a program loaded into the RAM 112 from an appropriate memory (e.g., the ROM 113 or the external memory 120). Further, it is presumed that image data is stored in the RAM 112 or the external memory 120.

When the display of a preview image is instructed by a user, the CPU 111 of the MFP 101 starts the processing according to the flowchart illustrated in FIG. 3. In step S200, the CPU 111 determines whether processing for generating preview images for all pages of target image data to be preview displayed has been completed. If the CPU 111 determines that the preview image generation processing is not yet completed for all pages of the target image data (NO in step S200), the operation proceeds to step S201. In step S201, the CPU 111 analyzes an image of one page included in the image data, and acquires (or extracts) attribute information.

In step S202, the CPU 111 generates a preview image based on the acquired attribute information analyzed in step S201 and the image of the target page. If the CPU 111 performs preview display processing before performing print processing, the CPU 111 can generate a preview image in such a way as to reflect print settings having been input beforehand by a user. For example, the CPU 111 displays a preview image indicating a resultant image obtainable when the print settings include a reduction layout (2in1 layout or 4in1 layout), two-sided setting, or staple processing, to enable a user to confirm a state of an output image.

If the CPU 111 completes the processing of step S202, the operation returns to step S200. The CPU 111 repeats the above-mentioned processing for the following page until the processing of steps S201 and S202 completes for all pages. In the flowchart illustrated in FIG. 3, the CPU 111 does not display any preview image before the preview image generation processing completes for all pages. However, the CPU 111 can start the preview image displaying processing immediately after the preview image generation processing completes for a single page to be first displayed. In this case, the CPU 111 executes the processing in steps S201 and S202 in parallel with the processing in step S203.

In step S203, the CPU 111 causes the display device 119 to display the preview image generated in step S202. In general, when the CPU 111 performs the preview display processing for image data including a plurality of pages, the first target to be preview displayed is image data of the first page.

In step S204, the CPU 111 receives a user instruction. If the CPU 111 determines that the instruction received in step S204 is enlarging or reducing the preview image, the operation proceeds to step S205. More specifically, in this case, the user can instruct enlarging or reducing the preview image by pressing the zoom button 104.

In step S205, the CPU 111 changes the display scale of the preview image. Subsequently, in step S209, the CPU 111 causes the display device 119 to display a preview image whose display scale has been changed. Then, the operation returns to step S204.

If the CPU 111 determines that the instruction received in step S204 is scrolling the preview image, the operation proceeds to step S206. In this case, the user can instruct scrolling the preview image by pressing the page scroll button 103. In step S206, the CPU 111 switches the page to be preview displayed to the following page (or the preceding page) and causes the display device 119 to display the selected page. Subsequently, in step S209, the CPU 111 causes the display device 119 to display a preview image of the following page (or the preceding page). Then, the operation returns to step S204.

If the CPU 111 determines that the instruction received in step S204 is moving (or changing) the display position of the preview image, the operation proceeds to step S207. In this case, the user can instruct moving (or changing) the display position of the preview image by pressing the viewing area selection button 105.

In step S207, the CPU 111 changes the display position of the preview image. Subsequently, in step S209, the CPU 111 causes the display device 119 to display a preview image whose display position has been changed. Then, the operation returns to step S204. If the CPU 111 determines that the instruction received in step S204 is closing the preview screen 100, the operation proceeds to step S208. In this case, the user can instruct closing the preview screen 100 by pressing the closure button 107. In step S208, the CPU 111 causes the display device 119 to close the presently displayed preview screen and display, for example, another screen that is arbitrarily selectable.

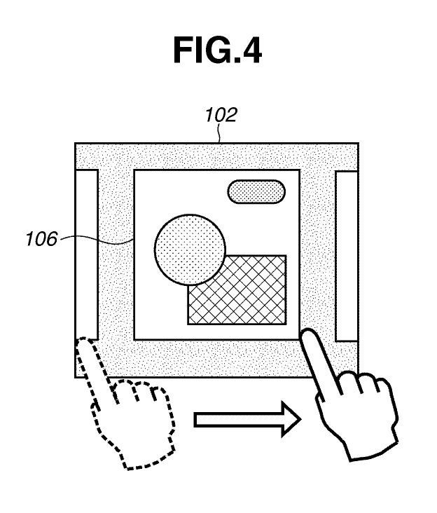

FIGS. 4 to 6 illustrate instructions that can be identified by the CPU 111 when a user performs a gesture instruction on the touch panel 118 in a state where the preview image 106 is displayed in the preview display area 102. The MFP 101 enables a user to perform a gesture instruction to control the display of the preview image 106, instead of using any one of the page scroll button 103, the zoom button 104, and the viewing area selection button 105. The gesture instructions are not limited to the above-mentioned flick and drag operations.

As another example of the gesture instruction, a user can perform a pinch-out operation to increase the distance between two or more touch points (in the touch-down state) on the touch panel 118 or a pinch-in operation that reduces the distance between two or more touch points. Further, it is useful that the MFP 101 is configured to recognize any other operations as gesture instructions.

Further, it is also useful to enable a user to determine whether to accept gesture instructions, as one of settings determining operations to be performed by the MFP 101. Further, it is useful that the MFP 101 does not display any one of the page scroll button 103, the zoom button 104, and the viewing area selection button 105 if the settings of the MFP 101 include accepting gesture instructions.

FIG. 4 illustrates a flick operation that can be performed by a user to change the page of the preview image 106 to be displayed, instead of using the page scroll button 103. If a user performs a flick operation to the right as illustrated in FIG. 4, the MFP 101 scrolls images rightward in such a way as to select a preview image of the preceding page (i.e., a page hidden on the left side) as an image to be displayed at the center of the preview display area 102. On the other hand, if a user performs a flick operation to the left, the MFP 101 scrolls images leftward in such a way as to select a preview image of the following page (i.e., a page hidden on the right side) as an image to be displayed at the center of the preview display area 102.

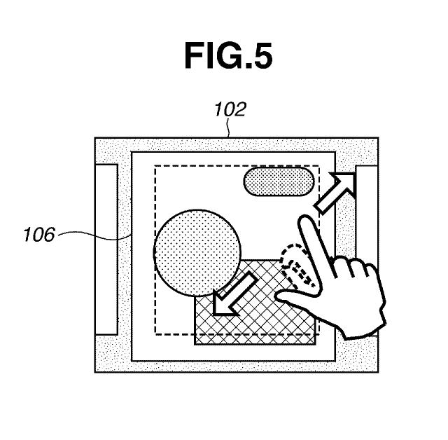

FIG. 5 illustrates a pinch-in operation or a pinch-out operation that can be performed by a user to change the display scale of the preview image 106, instead of using the zoom button 104. According to the example illustrated in FIG. 5, if a user performs a pinch-out operation, the MFP 101 increases the display scale in such a way as to display an enlarged preview image 106. On the other hand, if a user performs a pinch-in operation, the MFP 101 reduces the display scale in such a way as to display a reduced preview image 106.

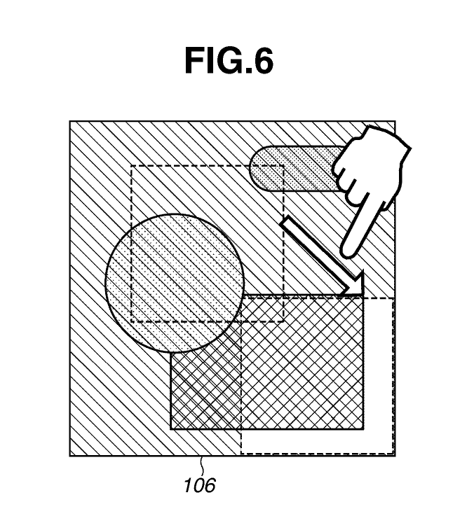

FIG. 6 illustrates a drag operation that can be performed by a user to change the display position, instead of using the viewing area selection button 105. According to the example illustrated in FIG. 6, a user performs a drag operation in an oblique direction from the upper left to the lower right, to instruct the MFP 101 to change the display position of the preview image 106. In this case, if the display scale is equivalent to a size capable of entirely displaying the preview image 106, the MFP 101 can disregard the user instruction to prevent the display position from being changed.

The correspondence relationship between a gesture instruction and a display control that can be realized by the gesture instruction is not limited to the examples illustrated in FIGS. 4 to 6 and can be any other type. For example, it is useful to perform a touch-down operation to change the display scale, perform a flick operation to change the display position, perform a pinch-in or pinch-out operation to scroll pages, and perform a double tap operation (i.e., performs the touch-down operation two times continuously) to close the preview screen 100.

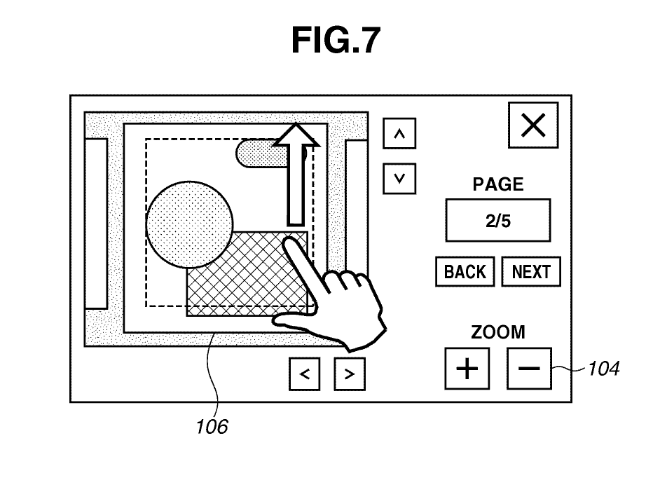

Further, the MFP 101 can change a combination of gesture instructions in the display control according to a selected mode. FIG. 7 illustrates a preview image 106 whose display scale has been changed based on a drag operation performed by a user in a state where the zoom mode is set by pressing the zoom button 104 (or by continuously pressing the zoom button 104). When the selected mode is not the zoom mode, the MFP 101 changes the display position of the preview image 106 according to a drag operation and displays the preview image 106 at the changed position, as illustrated in FIG. 6.

According to the example illustrated in FIG. 7, the MFP 101 determines whether to increase or decrease the display scale with reference to the direction of the drag operation and determines a change amount in the display scale based on an amount of movement in the drag operation. When the direction of the drag operation is a specific direction (e.g., upward direction), the MFP 101 increases the display scale. When the direction of the drag operation is the opposite direction (e.g., downward direction), the MFP 101 decreases the display scale.

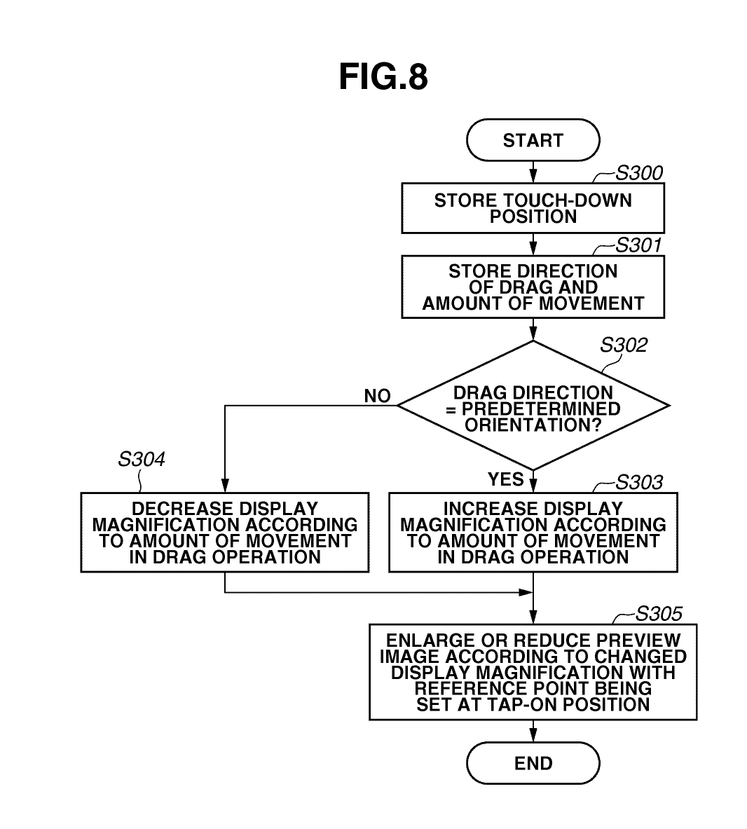

The operation illustrated in FIG. 7 is described in detail below with reference to a flowchart illustrated in FIG. 8. FIG. 8 is a flowchart illustrating details of the processing to be executed in step S205 illustrated in FIG. 3. To realize each step of the flowchart illustrated in FIG. 8, the CPU 111 of the MFP 101 executes a program loaded into the RAM 112 from an appropriate memory (e.g., the ROM 113 or the external memory 120). Further, it is presumed that image data is stored in the RAM 112 or the external memory 120. The CPU 111 starts the processing according to the flowchart illustrated in FIG. 8 if the instruction received in step S204 of the flowchart illustrated in FIG. 3 is instructing enlargement or reduction of the preview image. For example, to input such an instruction, a user can perform a drag operation in the zoom mode.

In step S300, the CPU 111 acquires an initial touch-down position in a drag operation performed by a user on the touch panel 118, and stores the acquired initial touch-down position in the RAM 112. In step S301, the CPU 111 identifies the direction of the drag operation (i.e., a moving direction) and an amount of movement (i.e., the distance between the touch-down position and a currently moving point) in the drag operation, which are detectable via the touch panel 118, and stores the direction of the drag operation and the amount of movement in the RAM 112.

In step S302, the CPU 111 determines whether the direction of the drag operation stored in step S301 (i.e., an input direction) coincides with an orientation being set beforehand in a program. The CPU 111 changes the content of display control processing according to a determination result. More specifically, if the CPU 111 determines that the direction of the drag operation coincides with the orientation being set beforehand (Yes in step S302), the operation proceeds to step S303. If the CPU 111 determines that the direction of the drag operation does not coincide with the orientation being set beforehand (No in step S302), the operation proceeds to step S304.

In step S303, the CPU 111 increases the display scale according to the amount of movement in the drag operation stored in step S301. On the other hand, in step S304, the CPU 111 decreases the display scale according to the amount of movement in the drag operation stored in step S301. The processing performed in each of steps S303 and S304 can be referred to as “display scale determination.”

In step S305, the CPU 111 enlarges or reduces the preview image according to the display scale changed in step S303 or step S304, with a reference point being set at the touch-down position stored in step S301.

Subsequently, the CPU 111 performs a display control to display the preview image having been enlarged or reduced in step S209 illustrated in FIG. 3. The operation returns to step S204 illustrated in FIG. 3. The CPU 111 performs the above-mentioned processing of the flowchart illustrated in FIG. 3 after the drag operation is completed. However, the CPU 111 can start the preview image display processing upon completing the processing in steps S301 to S305 if the drag operation is continuously performed.

A second exemplary embodiment is described below. In the above-mentioned first exemplary embodiment, the CPU 111 determines whether the direction of a drag operation stored in step S301 coincides with the orientation being set beforehand in a program. The CPU 111 determines whether to increase or decrease the display scale based on a drag direction determination result. However, it is useful that the CPU 111 determines whether to increase or decrease the display scale by checking if the direction of the drag operation stored in step S301 coincides with a predetermined orientation described in a setting file stored in the external memory 120. Further, it is useful that the CPU 111 changes (or corrects) the orientation described in the setting file based on a user instruction input via the touch panel 118.

The apparatus according to the present invention enables a user to change the display scale by changing the direction of a drag operation. For example, according to the example illustrated in FIG. 7, if the user performs a drag operation in an upward direction, the display scale becomes greater. If the user performs a drag operation in a downward direction, the display scale becomes smaller. Further, it is useful to increase the display scale when the direction of the drag operation is the right and decrease the display scale when the direction of the drag operation is the left. Similarly, it is useful to increase the display scale when the direction of the drag operation is the left and decrease the display scale when the direction of the drag operation is the right.

Further, in the above-mentioned embodiment, if it is determined that the direction of a drag operation coincides with a predetermined orientation (Yes in step S302), the CPU 111 increases the display scale according to an amount of movement in the drag operation. If it is determined that the direction of the drag operation does not coincide with the predetermined orientation, the CPU 111 decreases the display scale according to the amount of movement in the drag operation.

However, as an alternative embodiment, if it is determined that the direction of a drag operation coincides with a predetermined orientation, the CPU 111 can reduce the display scale according to an amount of movement in the drag operation. If it is determined that the direction of the drag operation does not coincide with the predetermined orientation, the CPU 111 can increase the display scale according to the amount of movement in the drag operation.

Further, in step S301, the CPU 111 stores an initial direction of a drag operation performed by a user (i.e., an initial direction of the “move” performed after a touch-down operation, more specifically, an initial input direction of the operation). In this case, the CPU 111 can increase the display scale if the momentary direction of a drag operation coincides with an initial direction of the drag operation because the drag state (i.e., “move”) continues until a user performs a touch-up operation.

Further, the CPU 111 can decrease the display scale if a user reverses the direction of the drag operation while keeping the drag state. For example, if a user initially performs a drag operation in an upper direction, it is useful that the CPU 111 performs a display control in such a way as to increase the display scale while the user continues the drag operation in the same (upper) direction. Further, it is useful that the CPU 111 performs a display control in such a way as to decrease the display scale if the user performs a drag operation in the opposite (i.e., downward) direction.

Further, in step S204, if an enlargement button of the zoom button 104 is pressed, the CPU 111 can set an enlargement mode. If a user performs a drag operation in a state where the enlargement mode is selected, the CPU 111 increases the display scale according to the amount of movement in the drag operation stored in step S301. Further, if a reduction button of the zoom button 104 is pressed, the MFP 101 can set a reduction mode.

If a user performs a drag operation in a state where the reduction mode is selected, the CPU 111 decreases the display scale according to the amount of movement in the drag operation stored in step S301. For example, the CPU 111 increases the display scale if a user moves a touch point in such a way as to move away from the touch-down position while continuing the drag operation, when the selected mode is the enlargement mode. On the other hand, the CPU 111 equalizes the display scale with the initial value if a user moves a touch point in such a way as to approach the touch-down position.

Further, the CPU 111 can display a scroll bar if a tap operation is received when the selected mode is the zoom mode. For example, if a user taps the preview display area 102 while pressing the zoom button 104, the CPU 111 displays the scroll bar on the preview screen 100. The CPU 111 can display a bar of the scroll bar at an arbitrary position according to a user instruction. For example, it is useful that the position of the bar is associated with the display scale in a table stored in the ROM 113. If a user instructs changing the position of the bar of the scroll bar, the CPU 111 controls the display scale according to the position of the bar.

Further, in the above-mentioned exemplary embodiments, the CPU 111 sets a touch-down position in a tap operation (or a drag operation) as a reference point that is required in the control of the display scale. Alternatively, it is also useful to set a specific position on a preview image as a reference point. Further, in the above-mentioned exemplary embodiments, the images to be displayed on a display unit quipped with a touch panel are preview images. However, the images to be displayed on the display unit are not limited to the above-mentioned example.

Further, the above-mentioned exemplary embodiments have been described with reference to the MFP. However, the present invention is applicable to any other image forming apparatus (e.g., a printing apparatus, a scanner, a facsimile machine, or a digital camera) or to any other information processing apparatus (e.g., a personal computer or a portable information terminal).

Further, in the above-mentioned exemplary embodiments, the operation to be performed by a user to realize an enlargement/reduction display is the drag operation. However, any other operation is usable to instruct the enlargement/reduction display. Further, the drag operation on the touch panel is replaceable by any other gesture instruction that touches the touch panel or a gesture instruction to be performed without touching the touch panel (e.g., a spatial gesture instruction).

Further, the display device that displays an image to be enlarged or reduced is not limited to a display unit equipped with a touch panel. It is useful to project an enlarged/reduced image on a screen using an image projecting apparatus (e.g., a projector). In this case, the CPU 111 detects a predetermined gesture instruction (e.g., a spatial gesture) if it is performed on the projected image, and controls scroll display processing.

### Other Exemplary Embodiment

Further, the present invention can be realized by executing the following processing. More specifically, the processing includes supplying a software program capable of realizing the functions of the above-mentioned exemplary embodiment to a system or an apparatus via a network or an appropriate storage medium and causing a computer (or a CPU or a micro-processing unit (MPU)) of the system or the apparatus to read and execute the program.

According to the above-mentioned exemplary embodiments, enlargement and reduction of image data can be performed in an intended manner. Further, the enlarged or reduced image data can be easily confirmed by a user.

Although the present invention has been described with reference to preferred exemplary embodiments, the present invention is not limited to specific exemplary embodiments. The present invention can be modified or changed in various ways within the scope of the claimed invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-181858 filed Aug. 20, 2012, which is hereby incorporated by reference herein in its entirety.

1. An information processing apparatus equipped with a touch panel, the information processing apparatus comprising:
a display unit configured to display image data;
a detection unit configured to detect a touch operation performed by a user on the touch panel;
a shifting unit configured to shift an operational mode into a zoom mode for enlarging or reducing the image data displayed by the display unit, if the detection unit detects a predetermined touch operation; and
a display control unit configured to control the display of the image data if the detection unit detects a drag operation performed on the touch panel after the operational mode is shifted into the zoom mode by the shifting unit, in such a way as to enlarge the display of the image data when a moving direction of the drag operation is a first direction and reduce the display of the image data when the moving direction of the drag operation is a second direction that is different from the first direction.

2. The information processing apparatus according to claim 1, wherein the display control unit is configured to enlarge the display of the image data according to a moving amount of the drag operation when the moving direction of the drag operation is the first direction, and reduce the display of the image data according to the moving amount of the drag operation when the moving direction of the drag operation is the second direction.

3. The information processing apparatus according to claim 1, wherein the display control unit is configured to move a display position of the image data according to the moving direction of the drag operation if the detection unit detects the drag operation before the operational mode shifts into the zoom mode.

4. The information processing apparatus according to claim 1, wherein the first direction is an upper direction and the second direction is a lower direction in a state where the image data is displayed by the display unit.

5. The information processing apparatus according to claim 1, wherein the display control unit is configured to realize an enlarged display or a reduced display of the image data, while fixing a specific position of the image data as a reference point.

6. The information processing apparatus according to claim 1, further comprising:
a setting unit configured to set the first direction and the second direction.

7. A method for controlling an information processing apparatus that includes a touch panel and a display device, the method comprising:
detecting a touch operation performed by a user on the touch panel;
shifting an operational mode into a zoom mode for enlarging or reducing the image data displayed on the display device, if a predetermined touch operation is detected; and
controlling the display of the image data if a drag operation performed on the touch panel is detected after the operational mode is shifted into the zoom mode, in such a way as to enlarge the display of the image data when a moving direction of the drag operation is a first direction and reduce the display of the image data when the moving direction of the drag operation is a second direction that is different from the first direction.

8. A computer readable storage medium storing a program that causes a computer to execute each step of the information processing method defined in claim 7.
